(19) United States
(12) Patent Application Publication
(10) Pub. No.: US 2001/0048905 A1
(43) Pub. Date: Dec. 6, 2001

(54) CATALYTIC CONVERTER FOR CLEANING THE EXHAUST GASES OF AN INTERNAL COMBUSTION ENGINE

(76) Inventors: JOHN KRAMER, RESIDENCE (XP); MARTIN SCHLEGL, RESIDENCE (XP)

Correspondence Address: KENYON & KENYON, ONE BROADWAY, NEW YORK, NY, 10004, US

(21) Appl. No.: 09/317,281

(22) Filed: May 24, 1999

(30) Foreign Application Priority Data
May 22, 1998 (DE) 19822858.9

(51) Int. Cl. B01D 53/74; B01D 53/86

(52) U.S. Cl. 422/180; 422/177; 423/212

(57) ABSTRACT

A catalytic converter for cleaning the exhaust gases of an internal combustion engine having a coating, for catalyzing the exhaust gases, on a carrier body which has passages in the direction of flow of the exhaust gases. To design a lighter-weight catalytic converter with high cleaning power, good response characteristics and good noise dampening properties, perforations are provided in the carrier body transversely to the passages.

### FIELD OF THE INVENTION

The present invention relates to a catalytic converter for cleaning the exhaust gases of an internal combustion engine.

### BACKGROUND INFORMATION

An exhaust gas catalytic converter with a honeycomb carrier body is disclosed in German Patent No. 42 23 134 A1. The carrier body is composed of multiple intertwined metal layers between which are provided passages for the exhaust gases. The passages lie in the direction of exhaust gas flow.

Due to its large number of metal layers, this catalytic converter has a high specific weight as well as a high thermal capacitance. After the internal combustion engine is started up cold, it must pass through a relatively long warm-up phase until the catalytic converter reaches the operating temperature needed for optimum cleaning. The noxious substances in the exhaust gas are insufficiently converted during the warm-up phase.

The high specific weight means that catalytic converters of only a certain maximum size can be installed. This limits the cleaning power of the catalytic converters.

Because of the high packing density of the carrier body, a high exhaust gas back-pressure, which inhibits flow, builds up in the exhaust line at the catalytic converter. This can produce a loss in performance by obstructing cylinder discharge.

Finally, catalytic converters of this type have a poor noise dampening performance.

### SUMMARY OF THE INVENTION

An object of the present invention is to provide a lighter-weight catalytic converter with a high cleaning power, good response characteristics, and good noise dampening properties.

The present invention provides a catalytic converter for cleaning the exhaust gases of an internal combustion engine, having a coating (2), for catalyzing the exhaust gases, on a carrier body (1) which has passages (3) in the direction of flow (4) of the exhaust gases. The present invention is characterized in that perforations (5) are provided in the carrier body (1) transversely to the passages (3).

The perforations increase the surface of the carrier body, which can then be provided with a catalyzing coating over a larger area. This increases catalytic converter performance, making it possible to use smaller catalytic converters while maintaining the same cleaning power. At the same time, the thermal capacitance is reduced so that the catalytic converter reaches its operating temperature more quickly.

The sturdiness of the carrier body, which is suitably designed as a one-piece component, remains largely the same in spite of the perforations. This makes it possible to use thin-walled, light-weight carrier bodies, in particular those made of metal.

The perforations run transversely to the main direction of exhaust gas flow in the direction of the exhaust line. The exhaust gas can also flow through the catalytic converter laterally to the main direction of flow. The exhaust gas dwell time in the catalytic converter and its contact with the converter coating is increased, which also improves the cleaning action.

Due to the additional means of dispersing the exhaust gas within the catalytic converter, the pressure difference upstream and downstream from the catalytic converter is reduced. The exhaust gas back-pressure is lower and does not obstruct cylinder discharge.

The perforated carrier body supports noise reflections which improve noise absorption.

### SUMMARY OF THE INVENTION

An object of the present invention is to provide a lighter-weight catalytic converter with a high cleaning power, good response characteristics, and good noise dampening properties.

The present invention provides a catalytic converter for cleaning the exhaust gases of an internal combustion engine, having a coating (2), for catalyzing the exhaust gases, on a carrier body (1) which has passages (3) in the direction of flow (4) of the exhaust gases. The present invention is characterized in that perforations (5) are provided in the carrier body (1) transversely to the passages (3).

The perforations increase the surface of the carrier body, which can then be provided with a catalyzing coating over a larger area. This increases catalytic converter performance, making it possible to use smaller catalytic converters while maintaining the same cleaning power. At the same time, the thermal capacitance is reduced so that the catalytic converter reaches its operating temperature more quickly.

The sturdiness of the carrier body, which is suitably designed as a one-piece component, remains largely the same in spite of the perforations. This makes it possible to use thin-walled, light-weight carrier bodies, in particular those made of metal.

The perforations run transversely to the main direction of exhaust gas flow in the direction of the exhaust line. The exhaust gas can also flow through the catalytic converter laterally to the main direction of flow. The exhaust gas dwell time in the catalytic converter and its contact with the converter coating is increased, which also improves the cleaning action.

Due to the additional means of dispersing the exhaust gas within the catalytic converter, the pressure difference upstream and downstream from the catalytic converter is reduced. The exhaust gas back-pressure is lower and does not obstruct cylinder discharge.

The perforated carrier body supports noise reflections which improve noise absorption.

The carrier body is suitably made of a metal carrier sheet which can simultaneously form the catalytic converter jacket and/or be composed of a three-dimensional carrier structure completely filling the interior of the catalytic converter. The carrier structure can also be designed as a carrier sheet and have a wavy shape.

### BRIEF DESCRIPTION OF THE DRAWINGS

Further advantages and suitable embodiments are given in the additional claims, description of figures, and drawings, where:

FIG. 1 shows a view of a wavy carrier body; and

FIG. 2 shows a view of a flat carrier body.

### DETAILED DESCRIPTION

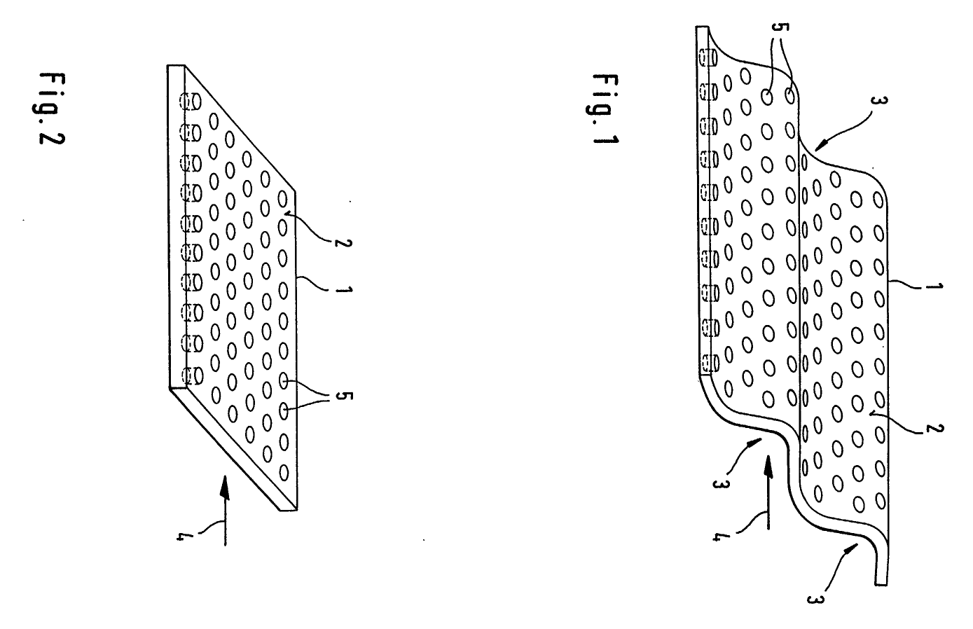

Carrier body 1 illustrated in FIG. 1 is part of a catalytic converter positioned in the exhaust line of an internal combustion engine, in particular a spark ignition engine. Carrier body 1 is the substrate for catalytic coating 2, for example platinum and rhodium, and has passages 3 through which the exhaust gas passes conducted in direction of flow 4. The exhaust gas thus comes into contact with coating 2 on carrier body 1, with the noxious substances in the exhaust gas being converted by reduction or oxidation. Direction of flow 4 largely corresponds to the arrangement of the exhaust line.

Carrier body 1 has a large number of perforations 5 which are provided in the carrier body in the form of ducts, penetrating the carrier body from one side to the other, so that additional flow components which deviate from main direction of flow 4 can form. The exhaust gases in the catalytic converter flow through passages 3 in direction of flow 4 as well as through perforations 5 at right angles to direction of flow 4, with the inner walls of perforations 5 being advantageously provided with a catalytic coating, just like the sheet surface. The perforations are suitably distributed evenly across carrier body 1 and all have approximately the same direction of passage, which runs more or less vertically to direction of flow 4 of the exhaust gas. In the embodiment illustrated, the perforations have a round cross-section. However, perforations with rectangular, diamond-shaped, or oval cross-sections are also possible.

According to a further embodiment, the perforations can also be arranged at random, with any cross-section, and at a non-vertical angle to the direction of exhaust gas flow.

Carrier body 1 is designed in the form of a wavy metal sheet, with passages 3 being formed by the peaks and valleys in the metal sheet waves. The wavy metal sheet is especially suitable as an insert in the converter interior, since multiple layers of the metal sheet are stacked vertically, preferably offset from one another, so that a valley of one layer lies on a peak of a second layer, with channels or passages 3 running between the layers. Passages 3 run along the length of the catalytic converter. A helix structure can be achieved by twisting the sheet layers. The converter interior is completely filled by a densely packed carrier structure. The reduced sheet thickness makes it possible to provide a light-weight carrier body.

Either perforated layers exclusively or alternating perforated and nonperforated layers can be stacked on top of one another. Both wavy and non-wavy layers can also be used.

According to a further embodiment, the carrier structure in the converter interior can also be designed in the form of a compact, one-piece component with perforations.

FIG. 2 shows a section of an essentially flat, wave-free carrier body 1 with a coating 2 and perforations 5 running vertically to direction of flow 4. This carrier body is also designed in the form of a metal sheet and is advantageously used as a cylindrical catalytic converter jacket which also acts as a support. The cylinder interior forms the passage lying in the direction of exhaust gas flow.

It is also possible to stack multiple flat layers on top of one another, separated by spacers, with the passages, oriented toward the direction of flow, running between two layers.

To optimize the acoustic properties of the exhaust manifold, the perforation structure can have a gradient along the length as well as across the width of the catalytic converter. In the longitudinal direction, perforated and non-perforated layers can alternate with each other.

What is claimed is:

1. A catalytic converter for cleaning exhaust gases of an internal combustion engine comprising:
a carrier body having passages in a direction of flow of the exhaust gases, the carrier body having perforations transversely to the passages; and
a coating on the carrier body for catalyzing the exhaust gases.

2. The catalytic converter as recited in claim 1 wherein the perforations are oriented perpendicular to the direction of flow.

3. The catalytic converter as recited in claim 1 wherein the carrier body is a carrier structure positioned in an interior of the catalytic converter.

4. The catalytic converter as recited in claim 1 wherein the carrier body is a carrier sheet.

5. The catalytic converter as recited in claim 4 wherein the carrier sheet forms a catalytic converter jacket.

6. The catalytic converter as recited in claim 4 wherein the carrier sheet has a wavy shape.

7. The catalytic converter as recited in claim 1 wherein the carrier body is made of metal.

8. A method of cleaning exhaust gases of an internal combustion engine comprising the steps of:
flowing the exhaust gases through a passage in a carrier body and through perforations in the carrier body, the perforations being transverse to the passage; and
catalyzing the exhaust gases through a coating on the carrier body.
